(19) United States
(12) Patent Application Publication
(10) Pub. No.: US 2008/0197612 A1
(43) Pub. Date: Aug. 21, 2008

(54) DISPERSING TUBE

(76) Inventor: JAMES T. KIRCHEN, Chippewa Falls, WI (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/972,258

(22) Filed: Jan. 10, 2008

Related U.S. Application Data
(60) Provisional application No. 60/901,350, filed on Feb. 15, 2007.

(51) Int. Cl. B60R 21/264

(52) U.S. Cl. 280/736

(57) ABSTRACT

A dispersing tube for an airbag deployment system is disclosed. The airbag deployment system includes a combustion chamber with a gas generant disposed inside and an ignitable pyrotechnic element for introducing a combustion product from the pyrotechnic element to the gas generant. The dispersing tube has a thin-walled tubular element mounted to the pyrotechnic element such that combustion products from the pyrotechnic element flow into the tubular element. The tubular element extends into the combustion chamber; the tubular element has selectively weakened areas formed along the tubular element which are adapted to fracture upon introduction of the combustion products. The selectively weakened areas extend along the length of the tubular element. The selectively weakened areas are thinned areas in the wall. The tubular element has an opening at an end. The tubular element is formed from a polymeric material.

### BACKGROUND OF THE INVENTION

The present invention relates to a dispersing tube for an airbag assembly. More particularly, the present invention relates to a dispersing tube for use in an airbag igniter assembly to disperse the combustion products more evenly through the air bag igniter chamber for contact with a gas generant.

Airbags are used in vehicles to mitigate the consequence of an accident. Current airbag deployment technology uses controlled combustion or an “explosion” to rapidly deploy the airbag. The chemicals that create this controlled explosion are housed in a canister within a chamber or housing.

In order to assure proper airbag deployment, the chemicals and the subsequent combustion must be contained within the chamber in such a manner as to assure complete, controlled combustion within certain given parameters.

In one known type of airbag assembly, the combustion or pyrotechnic containing canister is positioned at one end of an elongated chamber and a diffusion assembly (such as a screen) is disposed at an opposite end of the chamber. As combustion occurs, the combustion products react with a solid gas generant (typically in the form of pellets) disposed in the canister. The reaction between the combustion products and the gas generant pellets produces a gas that rapidly flows from the chamber, through the diffuser 14 screen end and out of the chamber to inflate the airbag.

This configuration functions quite well. However, it has been found to be desirable to better disperse the combustion products within the chamber for reacting with the gas generant material.

Accordingly, there is a need for a device to facilitate dispersing the combustion products from airbags through the airbag combustion chamber. Desirably such a device facilitates dispersing the products without impact on the effectiveness of the airbag deployment.

### BRIEF SUMMARY OF THE INVENTION

A dispersing tube for an airbag deployment system is disclosed. The airbag deployment system includes a combustion chamber with a gas generant disposed inside and an ignitable pyrotechnic element for introducing a combustion product from the pyrotechnic element to the gas generant. The dispersing tube has a thin-walled tubular element mounted to the pyrotechnic element such that combustion products from the pyrotechnic element flow into the tubular element. The tubular element extends into the combustion chamber; the tubular element has selectively weakened areas formed along the tubular element which are adapted to fracture upon introduction of the combustion products. The selectively weakened areas extend along the length of the tubular element. The selectively weakened areas are thinned areas in the wall. The tubular element has an opening at an end. The tubular element is formed from a polymeric material.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is schematic illustration of a known airbag inflator;

FIG. 2 is a side view of the combustion portion of the airbag assembly, showing the pyrotechnic and the canister within which it is contained (and illustrating the combustion process);

FIG. 3 is a side view of a canister and insulator cup

FIG. 4 is a side view of the airbag inflator of FIG. 1 showing the selectively thinned dispersing tube; and

FIGS. 5A and 5D are side views of the dispersing tube;

FIG. 5B is a perspective view of the dispersing tube; and

FIG. 5C is a plan view of the dispersing tube.

### DETAILED DESCRIPTION OF THE INVENTION

While the present invention is susceptible of embodiment in various forms, there is shown in the figures and will hereinafter be described a presently preferred embodiment with the understanding that the present disclosure is to be considered an exemplification of the invention and is not intended to limit the invention to the specific embodiment illustrated.

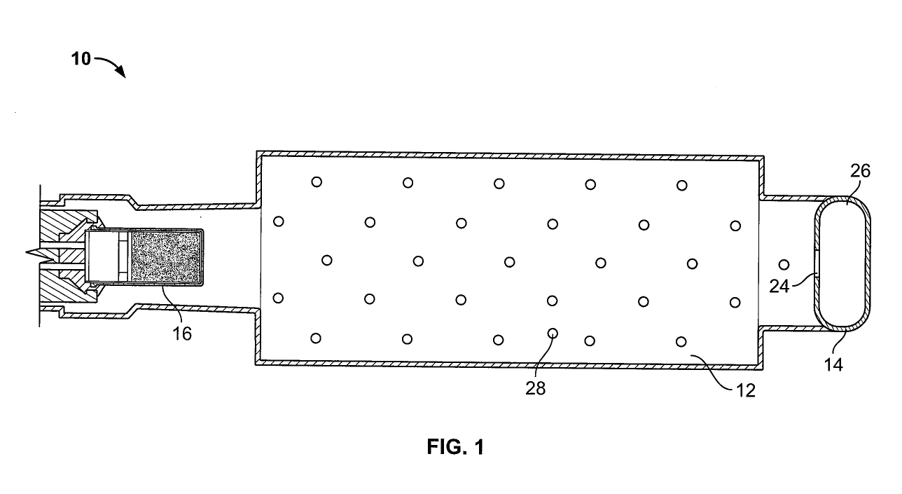

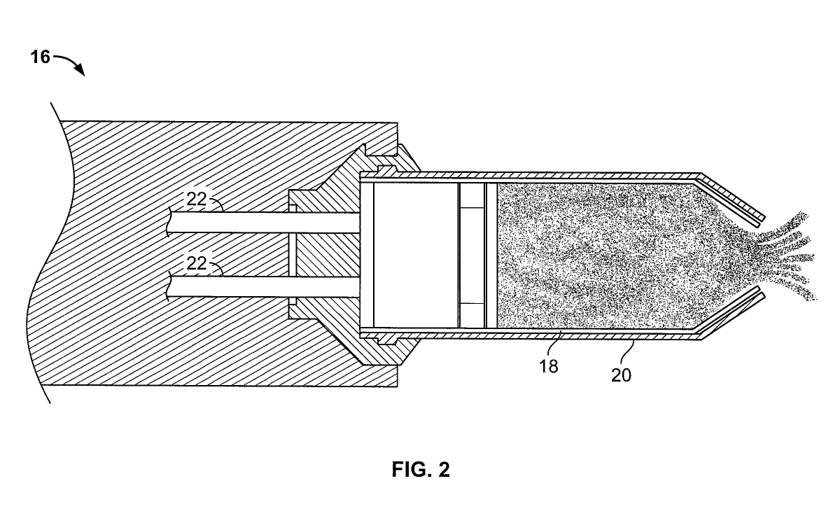

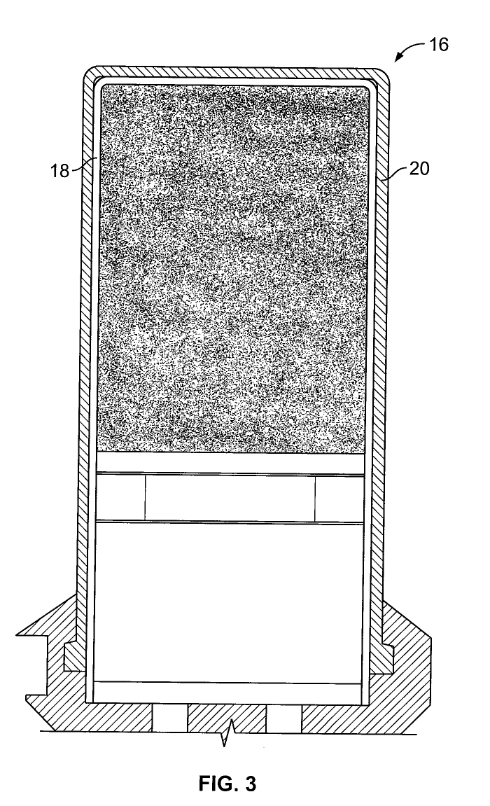

Referring now to the figures and in particular to FIGS. 1-3 there is shown a known airbag igniter assembly 10. The assembly includes, generally, a combustion chamber 12, and a diffuser 14. The pyrotechnic assembly 16 is contained within a canister 18 that is within a thin-walled cup 20, all of which is sealed. Leads 22 exiting from the pyrotechnic assembly are used to provide the necessary signal for deployment.

The diffuser 14 is disposed at an end of the chamber 12. An opening 24 provides flow communication between the chamber 12 and the diffuser 14. The diffuser 14 is provided to diffuse the expanding gases as the gases enter and inflate the airbag. A screen 26 is disposed between the chamber 12 and the diffuser 14 to contain any particulate matter.

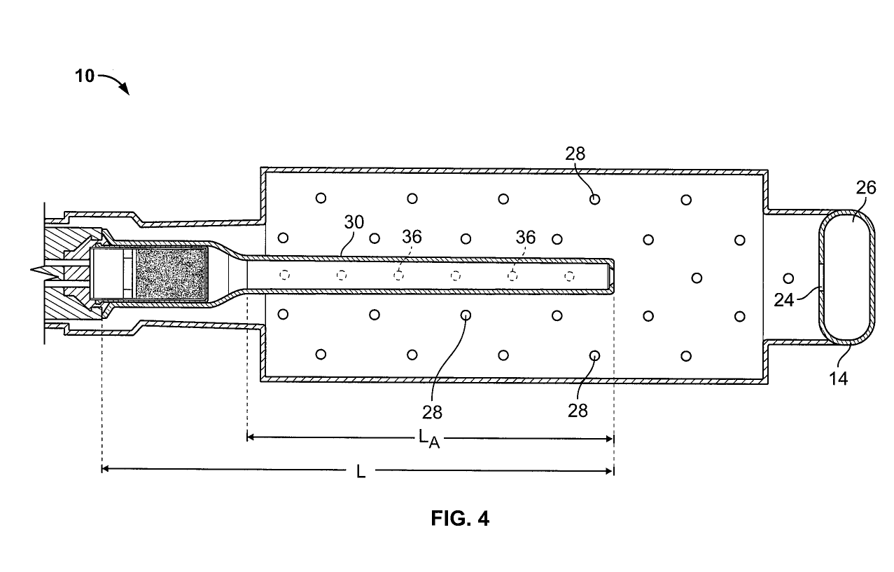

Referring now to FIG. 4, the expanding gases are produced, not by the combustion products alone, but by the reaction between the combustion products and a gas generant, indicated generally at 28 that is present in the chamber 12. Those skilled in the art will recognize and appreciate the gas generant materials and the pyrotechnic materials that can be used in the assembly.

The present dispersing tube 30 facilitates dispersing the combustion products (the pyrotechnic products) within the chamber 12 for contact with the gas generant. The tube 30 includes a thin-walled element 32 having a larger diameter open end 34 that is mounted to the pyrotechnic assembly, residing over the insulator cup 20 or directly over the canister 18. The diameter of the tube 30 may decrease, increase, or remain continuous along its length L to an end. The diameter reduction or expansion can be established in a one or more step-wise changes. In a present embodiment, the tube 30 is an elongated element with a diameter that decreases along its length L.

As the pyrotechnic is ignited, the products exit from the pyrotechnic assembly and enter into the open end of the tube 30, and flow along the length of the tube 30.

The tube 30 is provided with a plurality of sites, indicated generally at 36 at which the gases can escape from the tube 30. It will be appreciated that the tube 30 is formed from a sacrificial material (such as plastic) that will degrade or disintegrate as it comes into contact with the combustion products. Nevertheless, the tube 30 is formed with selectively weakened areas 36 to facilitate degradation or disintegration of the tube 30 and to promote the egress of the combustion products more evenly throughout the chamber.

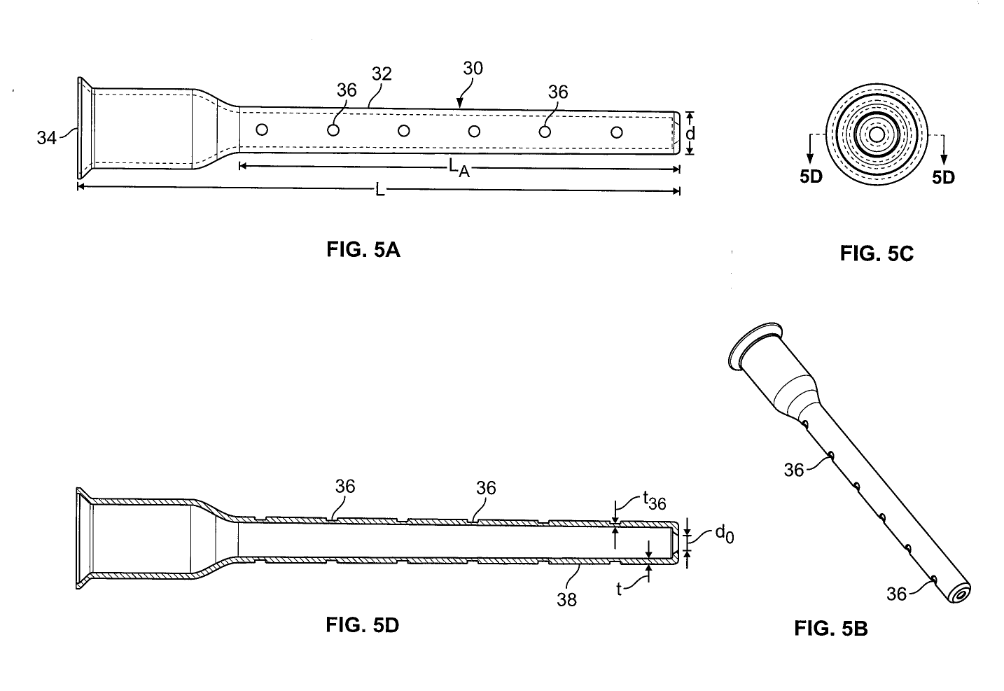

Referring to FIGS. 5A-5D, in a present tube 30, the selectively weakened areas are thinned areas or through-holes in the tube 30 wall 38. The thinned areas 36 can be formed as partial (i.e., localized thin areas) or through wall borings (e.g., holes, slots) formed in the wall, to provide specific or selective areas at which the combustion products are likely to penetrate the tube 30 to contact the gas generant. The end 34 of the tube 30 can include a through-wall bore.

In a present airbag assembly, the dispersing tube 30 is formed having an overall length L of about 70-80 millimeters (mm) and an active length LA (that is, the length over which the tube 30 is narrow and elongate, of about 50-60 mm. The non-thinned area wall thickness t along the length of the tube 30 is about 0.6 mm and the thickness t₃₆ of the wall at the weakened or thinned regions 36 is about ½ of the non-thinned wall, or about 0.3 mm thick. The tube 30 has a diameter d, along the active, dispersing length of about 5.0 to 5.5 mm and the through-wall opening dₒ at the tube 30 end has a diameter of about 2.0 mm.

It will be appreciated that the dispersing tube 30 facilitates a more rapid introduction of the ignition (or combustion products) to the end of the inflator, and thus expediting ignition of the generant 28 pellets inside the chamber 12. It will also be appreciated that the thinned regions 36 will provide not only a more rapid introduction of the combustion products to the pellets, but also a more even distribution or release of the combustion products, and in turn an increase in the speed and efficiency with which the generate is ignited.

It will be appreciated although certain materials are disclosed and described, various other suitable material could likewise be used, for example, in fabricating the various components of the invention.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover all such modifications as fall within the scope of the claims.

What is claimed is:

1. A dispersing tube for an airbag deployment system, the airbag deployment system including a combustion chamber having a gas generant disposed therein and an ignitable pyrotechnic element for introducing a combustion product from the pyrotechnic element to the gas generant, the dispersing tube comprising:
a thin-walled tubular element mounted to the pyrotechnic element such that combustion products from the pyrotechnic element flow into the tubular element, the tubular element extending into the combustion chamber, the tubular element having selectively weakened areas formed therein, adapted to disintegrate upon introduction of the combustion products therein, the selectively weakened areas extending along the length of the tubular element.

2. The dispersing tube in accordance with claim 1 wherein the selectively weakened areas are thinned areas in the wall.

3. The dispersing tube in accordance with claim 1 wherein the tubular element has an opening at an end thereof.

4. The dispersing tube in accordance with claim 1 wherein the tubular element is formed from a polymeric material.

5. An airbag deployment system comprising:
a combustion chamber having a gas generant disposed therein and an ignitable pyrotechnic element for introducing a combustion product from the pyrotechnic element to the gas generant; and
a dispersing tube having a thin-walled tubular element mounted to the pyrotechnic element such that combustion products from the pyrotechnic element flow into the tubular element, the tubular element extending into the combustion chamber, the tubular element having selectively weakened areas formed therein, adapted to disintegrate upon introduction of the combustion products therein, the selectively weakened areas extending along the length of the tubular element.

6. The dispersing tube in accordance with claim 5 wherein the selectively weakened areas are thinned areas in the wall.

7. The dispersing tube in accordance with claim 5 wherein the tubular element has an opening at an end thereof.

8. The dispersing tube in accordance with claim 5 wherein the tubular element is formed from a polymeric material.
